(19) United States
(12) Patent Application Publication
(10) Pub. No.: US 2005/0114818 A1
(43) Pub. Date: May 26, 2005

(54) Chip design command processor

(75) Inventors: Khosro Khakzadi, Woodbury, MN (US); Michael N. Dillon, Richfield, MN (US); Donald Amundson, New Prague, MN (US)

Correspondence Address: Leo Peters;LSI Logic Corporation, MS D-106, 1621 Barber Lane, Milpitas, CA, 95035, US

(73) Assignee: LSI Logic Corporation, Milpitas, CA (US)

(21) Appl. No.: 10/719,673

(22) Filed: Nov. 21, 2003

(51) Int. Cl. G06F 9/455

(52) U.S. Cl. 716/11

(57) ABSTRACT

A command processor of an integrated circuit design suite has a graphical user interface and a command interpreter for interpreting user commands. The graphical user interface is specified entirely by a user at run time. One or more design tools corresponding to processes within an integrated circuit design process operate under the control of the command processor and within the graphical user interface.

### CROSS-REFERENCE TO RELATED APPLICATIONS

The present application is related to the following U.S. Patent Applications: U.S. patent application Ser. No. 10/435,168, filed May 8, 2003; U.S. patent application Ser. No. 10/318,792, filed Dec. 13, 2002; U.S. patent application Ser. No. 10/318,623, filed Dec. 13, 2002; U.S. patent application Ser. No. 10/334,568, filed Dec. 31, 2002; U.S. patent application Ser. No. 10/465,186, filed Jun. 19, 2003; U.S. patent application Ser. No. 10/335,360, filed Dec. 31, 2002; U.S. patent application Ser. No. 10/664,137, filed Sep. 17, 2003; U.S. patent application Ser. No. 10/459,158, filed Jun. 11, 2003; and U.S. patent application Ser. No. 10/245,148, filed Sep. 16, 2002, the contents of which are hereby incorporated by reference in their entireties.

### BACKGROUND OF THE INVENTION

The present invention relates to user interfaces for software-based circuit design tools used primarily to design integrated circuits (IC). More particularly, the present invention relates to a system and method for allowing an end user complete control over the graphical user interface (GUI) of the command processor at run time including the appearance, menus, buttons and content of the GUI itself.

In the past few years, the demand for faster and cheaper ICs has grown exponentially. To address the demand for fast development and deployment of application specific ICs (which are sometimes referred to as “ASICs”), the chip design and fabrication industry has been moving toward “block-based” or “modular” design methodologies.

“Block-based” or “modular” design systems refer to a methodology of utilizing existing components to assemble a more complex, custom component. In particular, simple logic functions such as “AND”, “OR”, “NOR”, and other “gates”, and other more complex logic functions can be reduced to component blocks or modules. Additionally, existing component blocks or modules (also referred to in the art as “intellectual property blocks” or “IP blocks”) may be created, licensed from other design teams and/or companies. Moreover, the blocks may be supported by different design structures and environments and may be designed to meet different design requirements and constraints.

In general, software IC design tools provide a user with various aids for interacting with the underlying system, such as menus, buttons, keyboard accelerators, and the like. Such aids provide a visual representation for accessing various underlying functions, logical structures and the like.

The phrase “graphical user interface” or “GUI”, as used herein, refers to the objects and elements of a software application with which a user interacts when using the program. The GUI more generally refers to the “look and feel” of the software application and includes such items as interactive button bars, individual buttons and their appearance, menu bars, menu entries, tool bars, keyboard accelerators, window layout including window sizes and shapes, border colors and sizes, and so on. Additionally, the GUI includes the underlying functionality of the various graphical elements, such as the buttons and menus.

Although most software design tools and/or software applications have preferences or other facilities that allow a user to alter the appearance and content of menu, button and keyboard accelerators during program start up, such changes usually are made through the use of resource files. This approach, however, does not allow the user to alter the look and feel at run time. Actions performed through selection of certain menu items or buttons are assigned to a known procedure file. In other words, the actions performed through the selection of various interactive elements (e.g. buttons, menu options, and the like) by the user cannot be altered at run time. For example, while a user may add a button to a toolbar within the GUI, the button may only serve as a shortcut to an existing or known function. Moreover, the user typically cannot alter the graphical appearance of the button nor can the user alter the underlying function to which the button is linked.

While changes to the “look and feel” of conventional design tools can be made, such changes require application developers to change the source code or resource files, and can be time consuming. Moreover, such changes may require extensive programming know-how and significant debugging time. Thus, the conventional solution of altering the look and feel through resource files simply is not as flexible as allowing the user to assign arbitrary commands to menu, button or keyboard items and/or to change the appearance of graphical elements within the design tool at run time.

Conventional software-based IC design tools do not allow the end user to fully configure and change the look and feel of their design environment at run time. Unfortunately, this limitation prevents the user of the program from configuring and using the tool in a manner that is most suitable to that user, thereby preventing the user from achieving the highest productivity gains possible.

Just as in the physical work place where workers are most efficient when they can organize their workspace to fit the particular task and their own work style, IC designers work most efficiently when their design tool fits their design needs and style.

A design tool is therefore desirable, which is easy to use and which allows the user to fully customize and configure the look and feel of the design environment at any time.

### SUMMARY OF THE INVENTION

One embodiment of the present invention includes a command processor on a computer system. The command processor has a graphical user interface and a command interpreter. The graphical user interface provides a graphical interface to the computer system. The command interpreter interprets commands from a user and modifies the graphical user interface according to the interpreted commands.

Another embodiment of the present invention is a method of providing a fully customizable graphical user interface. Upon execution of a command processor, the system loads a top level command into a namespace. Graphical objects are built according to the commands. Functionality is assigned to the built graphical objects according to the commands. A user-interactive window is displayed containing the graphical objects according to TCL commands.

Another embodiment of the present invention is a method of providing a graphical user interface having no hard coded objects. A top level TCL command is loaded into a namespace upon execution of a command processor. A command interpreter interprets commands from a user. A graphical user interface is assembled based on interpreted commands from the user, such that all objects within the graphical user interface are user defined.

In another embodiment, an integrated circuit software design suite has a command processor with a graphical user interface and a command interpreter. The graphical user interface is specified entirely by a user at run time. The command interpreter interprets user commands to specify the graphical user interface. One or more design tools are provided which correspond to processes within an integrated circuit design process. The design tools operate under the control of the command processor and within the graphical user interface.

### BRIEF DESCRIPTION OF THE DRAWINGS

FIG. 1 is a simplified block diagram of a networked computer system on which the command processor and other design tools of the present invention can be implemented.

FIG. 2 is a simplified block diagram of a computer workstation, which an integrated circuit developer can access to use the command processor according to an embodiment of the present invention.

FIG. 3 is a simplified block diagram of a semiconductor slice from which the suite of generation tools can be used to create an integrated circuit.

FIG. 4 is a conceptual block diagram of the command processor according to the present invention.

FIG. 5 is a simplified flow diagram illustrating the operation of the command processor according to an embodiment of the present invention.

FIG. 6 is a simplified flow diagram of the overall flow of the integrated circuit design process utilizing the suite of generation tools in conjunction with the command processor.

FIG. 7 is a simplified block diagram of the graphics engine.

FIG. 8 is a simplified flow diagram of the operation of the graphics engine.

FIG. 9 is a screen shot of a user-specified graphical user interface according to the present invention.

FIGS. 10A and 10B are sample TCL scripts for implementing an object within the GUI and for calling a function based on user interaction with the object, respectively.

### DETAILED DESCRIPTION OF ILLUSTRATIVE EMBODIMENTS

One embodiment of the present invention is directed to a command processor for a suite of design tools, which are written as Tool Command Language (TCL) shells. A TCL shell is a script or program written in TCL, which is an interpreted script language. An interpreted program, sometimes called a script, is a program whose instructions are actually a logically sequenced series of operating system commands, handled one at a time by a command interpreter. In turn, the command interpreter requests services from the operating system.

According to one embodiment of the present invention, the command processor can be used to create a fully customized graphical user interface at run time. In particular, a programmer familiar with TCL scripts can write TCL code to generate a customized graphical user interface (GUI). Other users can then make use of the TCL when they run the executable. The GUI may be further customized or modified “on the fly” by any user familiar with TCL scripts and at any time. Thus, the command processor according to one embodiment of the present invention gives the user complete control over the appearance and contents of the GUI.

Generally, the command process according to one embodiment of the present invention includes a GUI and command language extensions that determine all GUI components. The GUI is a computer program written in the C++ programming language, for example. The command language extensions are TCL scripting language command extensions. The command processor uses a TCL command language interpreter to allow the user the capability to fully configure and change the contents of all menu, button and keyboard accelerators at any time during run time. It also provides the user with complete control over assigning commands to individual menu items, buttons or keyboard accelerators.

In general, the command processor treats all GUI components (i.e., windows, panes, buttons, and the like) as dynamic objects, which can only be created through the command processor at run time. A command processor utilizes a TCL command language interpreter. At program invocation, a single TCL command (at the top level) is added to the TCL name space. All subsequent GUI components (i.e., windows, panes, menus, buttons, and the like) are then be created by the user and will become subcommands of either the top level command or one of its subcommands. These TCL commands may be added or removed at any time, either at program invocation or at any other time during execution.

Additionally, since the entire look and feel of the GUI is determined at run time, none of the actions attached to the GUI components are hard coded. When a user, either through a script or through direct commands, creates a GUI component, the user also provides the TCL command associated with the GUI component. For example, if the user adds a menu entry to a pull down menu, the user provides an associated TCL command to be executed when the menu item is selected.

In general, a TCL scripting language extension is defined to create GUI components. The GUI components are dynamic objects represented as unique names in the TCL command name space. They can be created or removed at any time during program execution. Actions associated with these GUI components are entirely user defined. The user has full control over what a GUI component does. Actions associated with GUI components may be user defined or built in TCL commands. Additionally, GUI component details such as menu text, menu help, placement, number of items, sub-menu items, and the like are defined by the user.

Within the context of a suite of design tools, the command processor provides a user-defined GUI, from which the designer can call other design tools from the suite, as needed, in order to design, test and implement an integrated circuit layout. In particular, the command processor allows the designer to determine the design flow.

Additionally, each designer can use TCL scripts to create a custom environment. The custom user environment can then be loaded on command and without logging off. A user simply sits down at the machine that is already running the command processor, and simply loads his or her preference file, which causes the command processor to instruct the operating system to redraw the window according to the loaded properties. The result is that in the time it takes for the display to be redrawn, the user has all the menu options, buttons, and layout options that he or she is accustomed to at his or her own computer.

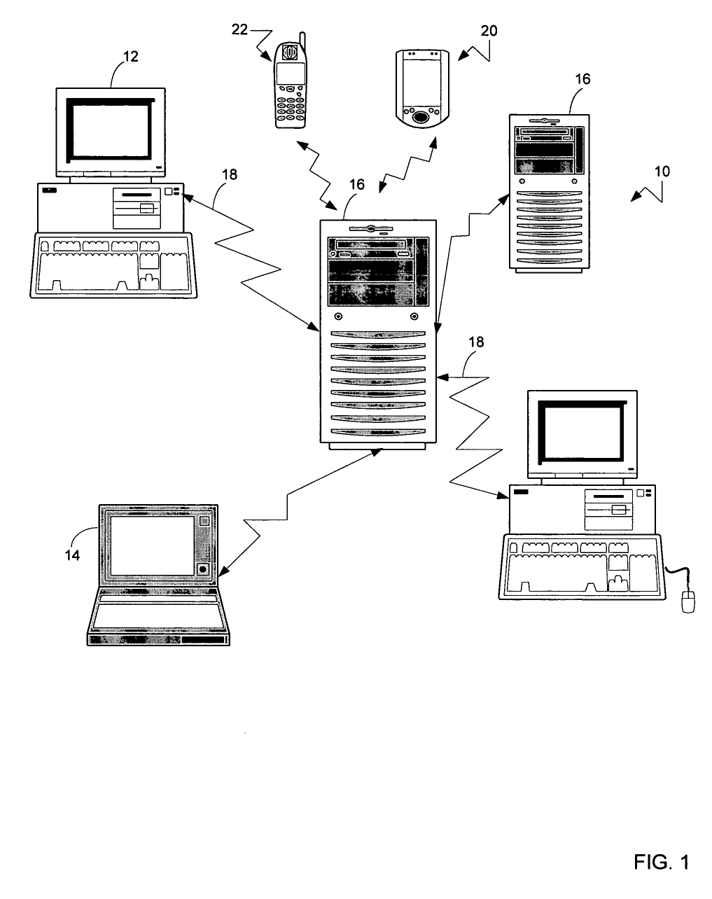

Referring to the drawings, FIG. 1 illustrates a computer system 10 on which the suite of integrated circuit generation tools can be installed and/or used. Computer system 10 includes one or more computers 12, which may be in network communication with one or more servers 16.

Connections 18 between the computers 12 and the one or more servers 16 may be physical cables, networks of cables, hubs and routers, or a wireless connection. The network itself may be a local-area network or a wide-area network. The network may be a public network such as the Internet, or even a telephone network. Additionally, any number of computers and other networked devices may be connected through the network, including printers, hand-held devices, and numerous other networked and networkable devices.

Computers 12 may be any type of computer, computer system or programmable electronic device, including a client computer similar to computers 12, a server computer similar to server 16, a portable computer 14, a handheld device 20, or even a web-enabled phone 22.

Computers 12 may be connected to a network as shown, or may operate as standalone devices. Computers 12, handheld devices 20, web-enabled phones 22, and laptop computers 14 will hereinafter be referred to as “a computer”, although it should be appreciated that the term “computer” may also include other suitable programmable electronic devices capable of allowing a chip designer to use the suite of generation tools.

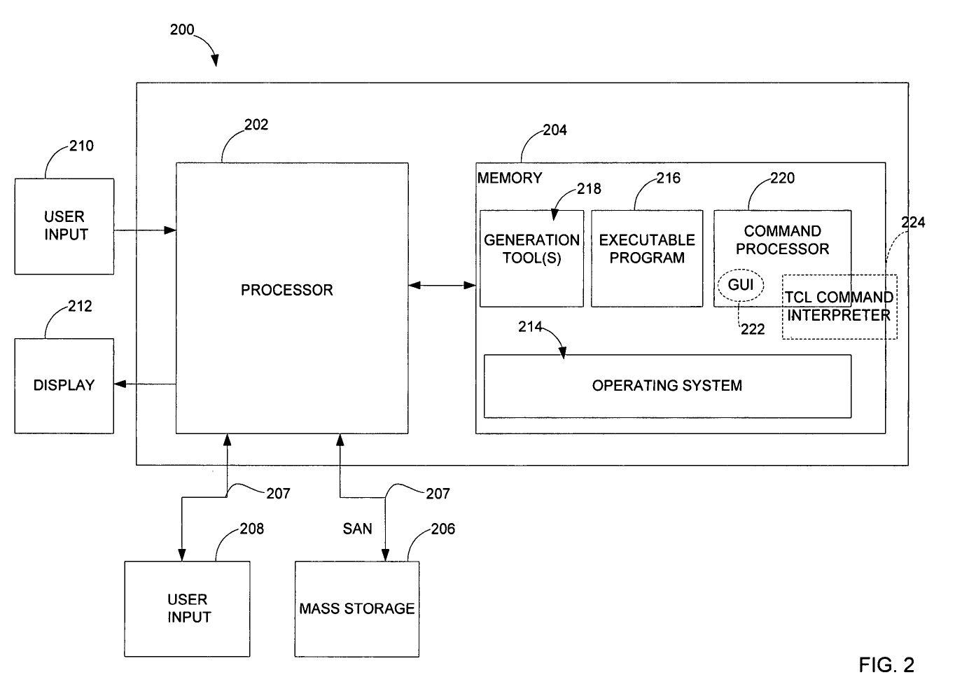

FIG. 2 illustrates an embodiment of a computer system 200 according to one embodiment of the present invention. A worker skilled in the art will understand that the computer system 200 may be a computer 12, a handheld device 20, a web-enabled phone 22, and a laptop computer 14, or any other electronic device capable of allowing a chip designer to use the suite of generation tools.

In general, the computer system 200 includes a processor 202 coupled to a memory 204. Processor 202 represents one or more processors or microprocessors. Similarly, memory 204 represents one or more random access memory (RAM) blocks and storage media, such as a hard disk, disk drive, flash memory, and the like. In general, memory 204 constitutes the main storage of the computer system 200, as well as any supplemental levels of internal memory such as cache memories, non-volatile or backup memories, read-only memories and the like. Additionally, memory 204 may include memory storage located elsewhere within the computer system 200 (e.g. any cache memory within the processor 202); storage capacity used as virtual memory (e.g. storage set aside on a mass storage device 206 coupled to the computer system 200 with a storage area network or “SAN”); storage capacity on a server or other computer via one or more networks 207.

For additional storage, the computer system 200 may also include a floppy disk drive, a hard disk drive, a direct access storage device, a CD drive, a DVD drive, and/or a tape drive. It will be understood that the computer system 200 may include many microchips and interface circuitry for interconnecting with one or more networks, with various peripheral devices (via USB, serial, SCSI, infrared, wireless, or any other type of connection).

The computer system 200 generally includes one or more user input devices 210 and a display 212. The user input devices 210 may include a keyboard, a mouse, a trackball, a joystick, a touchpad, a microphone, a touch-screen, a pen, and/or any other input device. Display 212 may be any device capable of displaying graphical information, including a CRT display, an LCD display panel, a plasma monitor, or any other display device.

Generally, the computer system 200 operates under the control of an operating system 214. Operating systems 214 may include Linux, Unix-based operating systems, Windows-based operating systems, Novell based operating systems, MacIntosh operating systems, Java-based operating systems, or any other operating system. For handheld devices, operating systems may include smaller implementations of the standard operating systems. In general, the operating system 214 executes various computer software applications, components, programs, objects modules and the like, such as an executable program 216.

As shown, the computer system 200 includes a suite of “integrated circuit” design and generation tools 218 (“tools 218”). Though the tools 218 are shown in memory 204, the tools 218 may be distributed over one or more computers or servers, and loaded into RAM memory as required. The processor 202 can access one or more of the tools 218, circuit data, various application components, executable programs 216, objects modules, and the like, which may be resident in one or more processors or in another computer coupled to the computer system 200 via the network 207. In other words, the generation tools 218 can be provided in a distributed or client-server computing environment, allowing the functions of the suite of generation tools 218 to be allocated to multiple computers over a network 207. By allowing the generation tools 218 to be distributed, some of the processing required to implement the various functions of the suite may be allocated to the various host computers as well.

The phrases “suite of generation tools”, “the generation tools”, “the suite” or “the tools” are used herein to refer to the suite of generation tools 218, which can be executed to implement elements of the integrated circuit design and implementation process. The tools 218 may be implemented as part of an operating system or as a specific application, component, program, object, module, or sequence of instructions. The tools 218 generally include one or more instructions that are resident at various times in various memory and storage devices in the computer system 200. When the one or more instructions are read and executed by the processor 202, the computer system 200 performs the necessary steps to execute various steps in the design process.

Finally, a command processor 220 is included in the memory 204 of the computer system 200. In general, the command processor 220 is an executable program that may be considered to be part of the generation tools 218, though the command processor 220 is shown as a separate element for the sake of clarity.

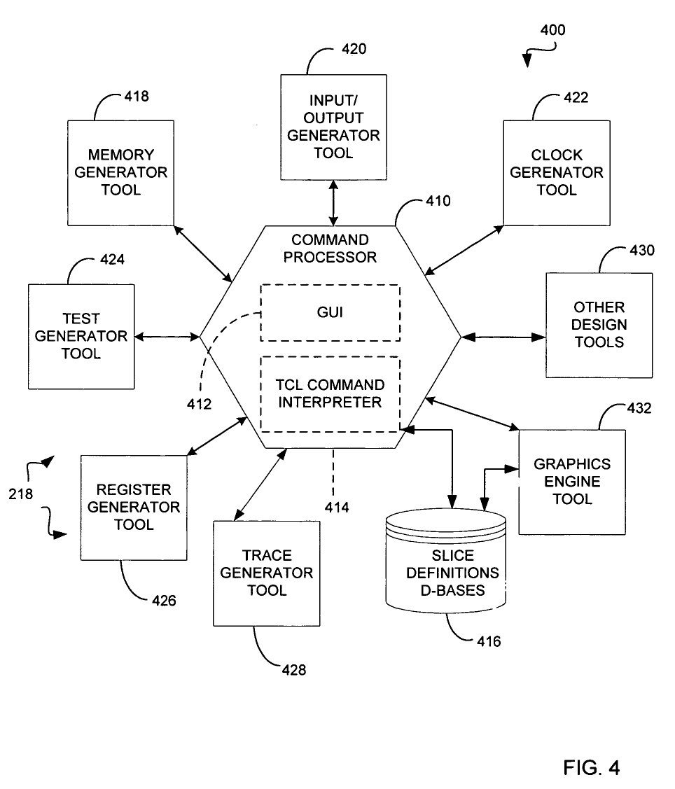

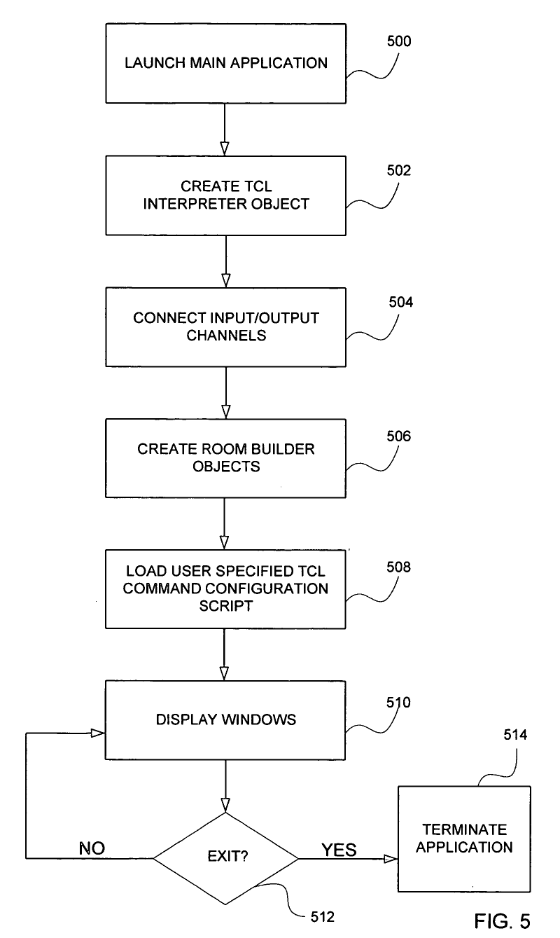

In general, the command processor 220 includes a GUI program 222 and a TCL command interpreter 224. The GUI program 222 is a compiled computer program written in the C++ programming language, for example. Other languages could certainly be used as well. The TCL command interpreter 224 interprets TCL commands provided by a user to generate dynamic objects within the GUI program 222, with which the user may then interact (as will be discussed in greater detail with respect to FIGS. 4 and 5).

Conceptually, the command processor 220 can be thought of as a blank slate. Specifically, the user can customize the GUI 222 using TCL commands interpreted by the TCL command interpreter 224. More specifically, objects, functions, and the entire look and feel of the GUI 222 are entirely determined by the user. Thus, the command processor 220 provides a platform for dynamic and efficient customization of the integrated chip designer's design tool environment. From within the command processor 220, the user can define GUI objects with which he or she can interact in order to complete an integrated circuit design and layout. The GUI objects may also link to the generation tools 218, to an executable program 216, or to custom scripts or compiled TCL modules, allowing the designer complete flexibility in organizing his or her design workspace.

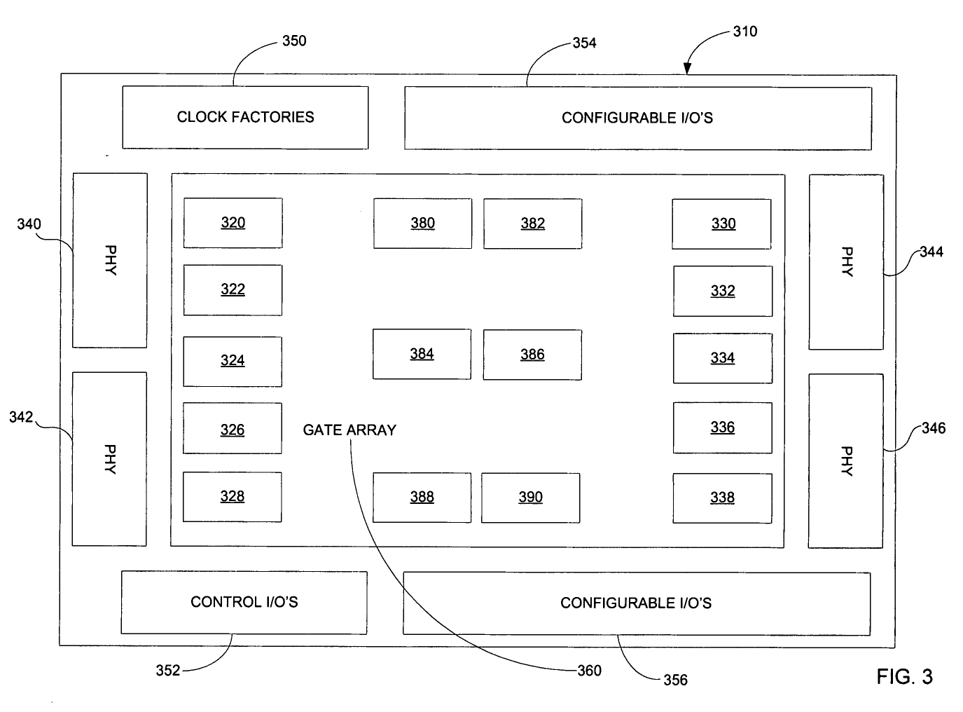

FIG. 3 shows a microchip slice 310. The slice 310 is a partially manufactured semiconductor device in which the wafer layers up to the connectivity layers have been fabricated. The slice 310 includes a base semiconductor wafer, which may be formed from silicon, silicon germanium, gallium arsenide, silicon-on-insulator, other Type II, Type III, Type IV and Type V semiconductors, and the like. Generally, the slice 310 also includes blocks or hard-macros (“hardmacs”) that have been diffused into the semiconductor layers of the wafer.

The process of diffusion means that during fabrication of the wafer layers, transistors or other electronic devices or structures have been arranged in the wafer layers to achieve specific functions. One such function includes diffused memories 320, 322, 324, 326, 328, 330, 332, 334, 336, 380, 382, 384, 386, 388 and 390 (hereinafter referred to as diffused memories 320-338 and 380-390). Other functions can include data transceiver hardware, such as Input/Output (I/O) PHYs 340-346, clock factories including PLLs 350, control I/Os 352, configurable I/O hardmacs 354 and 356. Each of the hardmacs have an optimum arrangement and density of transistors to realize its particular function.

The slice 310 further includes an area of transistor fabric 360 for further development of the slice 310 using the suite of generation tools 218. Transistor fabric 360 is an array of prediffused transistors diffused in a regular pattern that can be logically configured by the suite of generation tools 218 to achieve different functions. A “cell” refers to a cell library which contains a logical circuit element. A placed instance of a cell on a circuit layout forms the logic gates of the circuit design.

The slice 310 is one embodiment of a microchip slice that can be used with the suite of generation tools 218. Other slice configurations are contemplated for different families of devices. For example, for a printing device, the I/O connections and the memory locations may be different. Some of the blocks of diffused memory 320-338 and 380-390 may have been compiled by a memory generator for specific sizes, timing requirements, connections, and the like. On any given slice 310, the placement of the hardmacs relative to other diffused objects and to reserved areas of the transistor fabric is optimized to achieve the desired timing and performance, both within the slice 310 and outside the slice 310 when the slice is connected to a larger board.

One of skill in the art will appreciate that the slice 310 is only one example of a slice and its components. Different slices may contain different amounts and arrangements of transistor fabric 360, different amounts of diffused and/compiled memories, fixed and configurable I/O blocks, clocks, and the like, depending on the functional requirements of the final integrated chip. For example, if the final chip is intended for use in a communication and/or network integrated circuit, the periphery of the slice 310 will contain many I/O cells that have been fixed as PHYs and/or that can be configured differently from one another. Likewise, if the final integrated chip is intended to be a specialized microprocessor, then it may not have as many I/O hardmacs or configurable I/O, and may have different amounts of diffused registers and memories. Thus, the slices 310 are customized to a certain extent based on the different semiconductor products for which they are intended. The slice 310 may optionally include the contact mask and some of the fixed higher layers of connectivity for distribution of power, ground and external signal I/O.

A slice definition is a detailed listing of the features available on the slice 310, such as the area and availability of the transistor fabric, the I/O ports, available memory locations, hardmac requirements, slice cost, ideal performance characteristics, expected power consumption, and other functional requirements. For example, for memory elements the slice definition includes details of the area and physical placement of the memory array and its interface/connection pins; the bit width and depth of the memory array; memory array organization (including numbers of read/write ports; bit masking, and the like); memory cycle time; and memory power estimates. For clock elements, the slice definition provides the frequencies at which the slice may operate, the duty cycle, and the like. Other details of the slice definition include the configuration of the transistor fabric 360 and the diffused and compiled elements, the status of the logic, the required control signals and the features enabled by the control signals, testing requirements, location and number of elements on the slice, and the like.

Referring now to FIG. 4, an embodiment of a system 400 according to one embodiment of the present invention is shown. The system 400 includes a command processor 410 having a graphical user interface (GUI) 412 and a TCL command interpreter 414. The command processor 410 is connected with a slice definitions database 416 via any type of communications link. The command processor 410 is also in communication with a plurality or suite of generation tools (corresponding to the suite of generation tools 218 shown in FIG. 2). The specific functionality of the command processor will be discussed following an introduction to some of the tools of the suite of tools 218.

As shown, the suite of generation tools 218 include a memory generator tool 418, an I/O generator tool 420, a clock generator tool 422, a test generator tool 424, a register generator tool 426, and a trace generator tool 428. Other design tools 430 may also be included or added, including custom design tool, standalone applications or scripts, and various other optimization tools and utilities. Finally, a graphics engine tool 432 may be included with the suite.

The suite of generation tools 218 generally interprets an application set and a customer's requirements for an integrated circuit. Preferably, the application set and the customer's requirements are programmed according to standard guidelines for easy interpretation by the suite of tools 218. The suite of generation tools 218 generates logic and design views to satisfy the customer's requirements. The suite of tools 218 are generally self-documenting and self-qualifying. A particularly advantageous characteristic of the design tools 218 is that they update in real time to store the state of what is generated. This characteristic allows the user to execute each of the tools in the suite of tools 218 in an iterative fashion to include incremental design changes and then to consider and analyze the effect of each incremental change. Alternatively, each tool or the entire suite of tools 218 can be run in a batch process for global optimization. Additionally, each tool, the customer's requirements, and the application set may be stored on the same or different computers, a storage area network (SAN) mass storage system, or one or more stand-alone storage devices, each connected to the user's computer by a network 207.

Generally the suit of generation tools 218 consists of integrated circuit design tools that fall into one of two categories: tools that manage the various resources of the slice as presented in the application set; and tools that enhance productivity. Typical of the resource management tools are those that specifically create usable memories, such as I/O's, clocks, and tests.

One such resource management tool is a memory generator 418, such as that disclosed in U.S. patent application Ser. No. 10/318,623, filed Dec. 13, 2002, which is incorporated herein by reference in its entirety. The memory generator tool 418 manages existing memory resources on a pre-fabricated chip slice and creates synthetic logical memory elements from a varied collection of available diffused and/or RCELL memory arrays and/or transistor fabric on the slice definition. The memory generator tool 418 also generates memory wrappers with memory test structures, first in first out (FIFO) logic, and logic required to interface with any other logic elements within the fixed module or within user modules.

The I/O generator tool generates 420 the I/O netlist of the configuration and allocation of external I/O's according to the customer requirements. The I/O generator tool 420 may also generate and manage an RTL module that ties or closes unused I/O cells to an appropriate inactive state, such as described in U.S. patent application Ser. No. 10/334,568, filed Dec. 31, 2002, which is incorporated herein by reference in its entirety.

A clock generator tool 422 creates a collection of clocks and resets that form a clock tree as specified by customer requirements. The clock generator tool 422 also ensures that the correct test controls for clocking are created and connected at the same time within the context of the slice definition. Thus, the clock generator tool 422 produces testable clock generation, phase lock loop (PLL) wrappers, and coordinated reset mechanisms, such as that described in U.S. patent application Ser. No. 10/664,137, filed Sep. 17, 2003, which is incorporated herein by reference in its entirety.

A test generator tool 424 generates test structures and connects logical elements to the generated test structures. The test generator tool 424 manages the test resources, determines what resources are being used on the chip, and produces appropriate bench files, such as those disclosed in U.S. patent application Ser. No. 10/459,158, filed Jun. 11, 2003, which is incorporated herein by reference in its entirety.

One of skill in the art will recognize that other resource management tools are possible given knowledge of the structure and function of the requisite logic. Some implementations may combine features (for example, a memory generator tool may be combined with a test generator tool), and exclude other features in order to yield a new tool. Such design tools incorporating pieces of tools for use in transforming transistor fabric into functional semi-conductor modules are within the scope of the present invention.

Typical of the enhancement tools is a register generator tool 426, which automates the process of documenting, implementing, and testing registers and internal memories. Additionally, the register generator tool 426 may configure registers that are not part of the data flow. One such register generator tool is disclosed in U.S. patent application Ser. No. 10/465,186, filed Jun. 19, 2003, entitled “AN AUTOMATED METHOD FOR DOCUMENTING, IMPLEMENTING, AND TESTING ASIC REGISTERS AND MEMORY.”

Another generator tool that may be part of the suite is a trace generator tool 428. The trace generator tool 428 configures bare or unused resources, such as unused diffused memories. The generator tool 428 configures the unused resources for trace arrays where state and debug signals can be input for logic analysis and trace storage, such as disclosed in U.S. patent application Ser. No. 10/245,148, filed Sep. 16, 2002, which is entitled “AUTOMATED USE OF UNALLOCATED MEMORY RESOURCES FOR TRACE BUFFER APPLICATIONS”, and which is incorporated herein by reference in its entirety.

Other design tools 430 may be constructed from functionality of existing design tools, or may completely customized by the customer so as to facilitate and enhance the design and fabrication process. Such other design tools 430 may also be tools produced by third parties, or may simply be TCL or other scripts that can be loaded into the command processor.

The slice definition database 416 is a database that stores all of the layout and configuration information for a given pre-fabricated chip slice. Generally, the slice itself is of little use to the designer needing to develop register transfer logic (RTL), so some representation of the diffused resources on the slice is necessary. In other words, the specific location and allocation of RTL logic, I/Os, diffused memory locations, and the like are abstracted for use in the design process. These abstractions are sometimes referred to as shells. Such shells are the logical infrastructure that makes the slice useful as a design entity. Using the suite of generator tools 218 and the abstracted data stored in the database 416, a chip designer can integrate his or her customer requirements with the resources of the slice, verify and synthesize designs generated by each tool, insert clocks, test interconnects, and integrate the design elements together to create a complete integrated chip.

The command processor 410 facilitates the use of the other design tools. After the user launches the GUI executable 412 of the command processor 410, the command processor 410 loads the TCL top level command into the TCL namespace. Finally, the command processor 410 loads the GUI components created by the user. None of the actions attached to the GUI components are hard coded, meaning that the user defines the functionality of each GUI component either by attaching a script or a direct command to the GUI component.

The command processor 410 allows the user to fully customize the look and feel of his or her design “workspace”. Specifically, the design processor 410 utilizes the TCL command interpreter 414 to interpret TCL commands for configuring a fully customizable GUI. From the custom GUI workspace, the user can then design, test, optimize, and process the chip layout. By allowing the user to customize the GUI at run time, the user can design the look and feel of the GUI to best suit his or her needs. In other words, the user can create custom GUI objects and components to quickly access the other design tools 218 that he or she most often uses. Through the command processor 410 and the associated tools, the user can efficiently design an integrated circuit. The resulting design, moreover, is a qualified netlist with appropriate placement and routing consistent with the existing resources and including external connections. To create a customized chip, all that is needed is a small set of remaining masks to generate or create the interconnections between the pre-placed elements.

As shown in FIG. 4, the command processor 410 can be utilized as a central element of the design tool suite 218. In particular, the command processor creates a TCL interpreter object, connects input/output channels, creates room builder objects, and loads user specified TCL command configuration scripts to construct a fully customized GUI, from which the user can access any of the design tools, and control the entire integrated circuit design process.

A graphics engine tool 432 may also be provided. To understand the functioning of the graphics engine tool 432, it is important to understand that the chip layout or logic interconnect layouts for particular logical functions or blocks are typically stored in databases, which are typically referred to as cell libraries. A specific interconnect and transistor layout for a particular block can be considered a single database. In order to integrate custom logic from customers, it is sometimes necessary to access netlists and/or databases produced by a customer. Such databases may be in an unknown format.

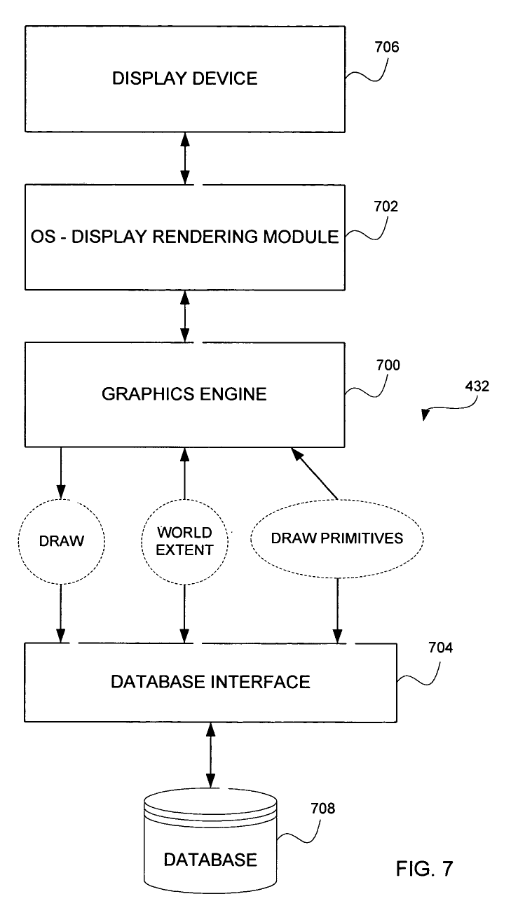

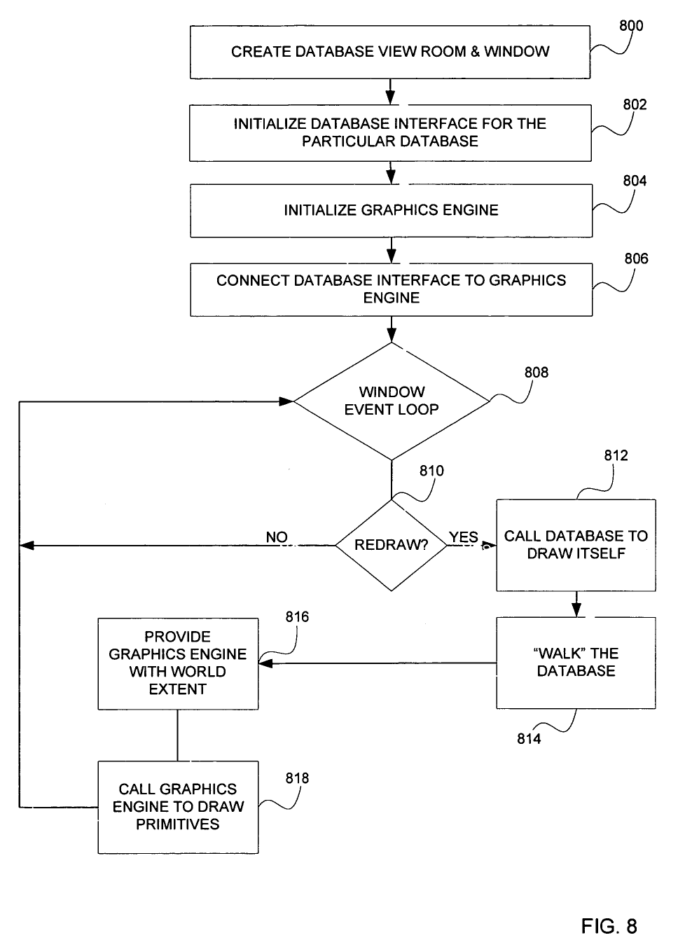

The graphics engine tool 432 can access and draw information from such databases, making the contents of the database accessible without having to know the structure of the database. When making custom chips or integrated circuits, the graphics engine tool 432 can be particularly useful, because it allows the designer access to databases he or she may otherwise be unable to access. The graphics engine tool will be described in greater detail with respect to FIGS. 7 and 8.

FIG. 5 shows a simplified flow diagram of the functioning of the command processor 410. First, the user launches the main application or command processor (step 500). The command processor 410 creates a TCL interpreter object (step 502), and connects input and output channels (step 504). Then, the command processor 410 creates room builder objects (step 506). In this step, base class object constructors add various builder object command names to the TCL namespace, and destructors remove commands and object command names from the TCL namespace.

The command processor 410 loads user specified TCL command configuration scripts (step 508), either from a file or from direct user input. In general, the user specified TCL command configuration scripts may be understood to be user specified room commands. Objects created by the user in step 506 process these commands. Once rooms and room windows are created, menus, menu items, buttons, accelerator keys, and the like can be added to specific room windows. The addition of such elements within the room windows also requires that the user specify the specific functionality to which the various objects correspond.

Finally, the command processor 410 displays the windows (step 510), which were created by the user specified TCL commands, and enters the event loop. The command processor 410 processes the event loop until the user chooses to exit (step 512), which causes the application to terminate (step 514).

It will be understood by workers skilled in the art that the specific implementation of the GUI is customized at this level. A user familiar with TCL scripts can script a customized GUI that can be utilized by all designers within a particular enterprise. Alternatively, each user can specify custom preferences in TCL scripts that can be loaded by the user as desired, such that the GUI for each individual user within an enterprise can be visually and functionally different. User specified scripts need not be determined prior to run time, thereby allowing the user to fully customize the functionality of the application at any time in order to facilitate the design flow process.

From within the command processor 410 and the GUI 412, the user is free to call any of the design tools 218 at any time. The user can specify the rooms, the views, and the various objects such that a click on a button within a tool bar or the selection of an element within a menu can call one of the design tools or, alternatively, a custom script or application.

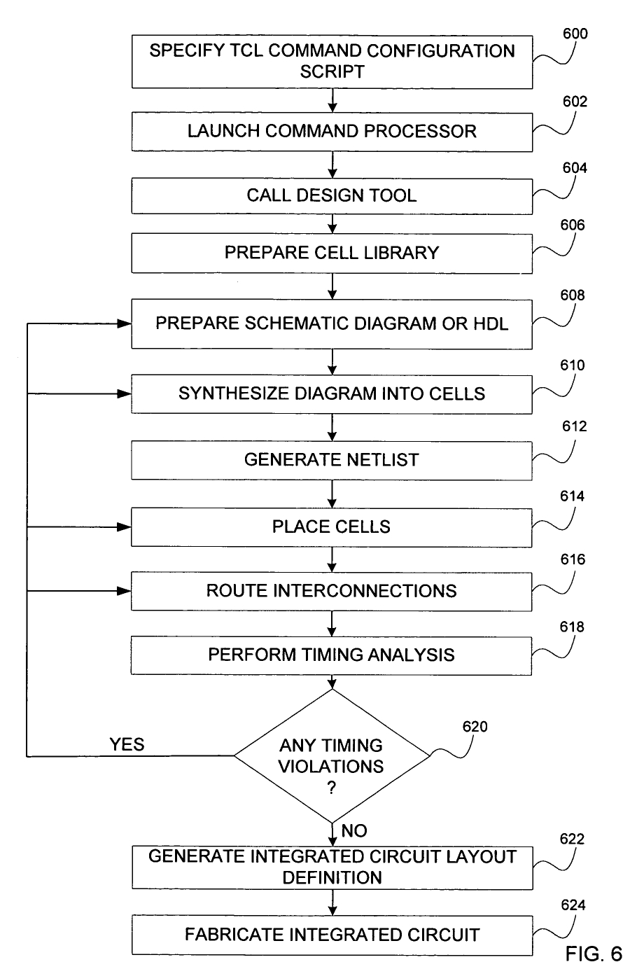

FIG. 6 shows a simplified flow diagram of the design process using the command processor 410 according to one embodiment of the present invention. As shown, the end user first specifies the TCL command configuration script (step 600). The TCL command configuration script can be a single text file, a header file referencing multiple TCL files, or maybe specified as individual scripts after launching the command processor 410. Next, the user launches the command processor 410 (step 602), which at program invocation, adds a single TCL command (the top level) to the TCL name space. At this point, the user specified TCL command configuration script can be loaded into the TCL name space, thereby constructing all of the user specified GUI components, including the windows, panes, menus, buttons, and the like.

In general, as previously discussed, all subsequent GUI components are created by the user and will correspond either to subcommands of the top level command or subcommands of a subcommand. Each GUI component and its associated functions or commands may be added or removed at any time, either at program invocation or at any other time during execution.

As previously discussed, none of the actions attached to the GUI components are hard-coded. Thus, when the user either through a script or through direct command creates a GUI component, the user also provides TCL command associated with the GUI component. For example, if the user adds a menu entry to a pull down menu, he or she also provides a TCL command to be executed when the menu item is selected.

Once the GUI is established by the user specified TCL command configuration scripts, the user can access any of the existing design tools (step 604) or a custom application to begin the process of designing integrated circuit. The process flow may then proceeds as a conventional integrated circuit design process. Specifically, the user may call a design tool (step 604) and begin preparing a cell library (606). The user may then prepare schematic diagram or HDL file (step 608).

The conventional layout process includes steps 606-624. The first step in the layout process is to prepare a cell library (step 606). The cell library is typically prepared by the manufacturer of the integrated circuit. In general, each cell in the cell library includes a cell library definition having physical data and timing characteristics associated with that cell and having a transistor width input variable and a cell loading input variable.

At step 608, the logic designer prepares a schematic diagram or HDL specification in which functional elements are interconnected to perform a particular logical function. Once the schematic diagram or HDL specification is complete, it is passed to a series of computer aided design tools, beginning at step 610, which assist the logic designer in converting the schematic diagram or HDL specification to a semiconductor integrated circuit layout definition which can be fabricated. The schematic diagram or HDL specification is first synthesized, at step 610, into cells of the cell library defined in step 606. Each cell has an associated cell library definition according to the present invention.

At step 612, the design tools generate a netlist of the selected cells and the interconnections between the cells. At step 614, the selected cells are placed by arranging the cells in particular locations to form a layout pattern for the integrated circuit. Once all the selected cells have been placed, the interconnections between the cells are routed, at step 616, along predetermined routing layers.

A timing analysis tool is used, at step 618, to generate timing data for electrical signal paths and to identify timing violations. The timing analysis tool first determines the output loading of each cell based upon the routed interconnections of that cell and the input loading of the driven cells.

The timing analysis tool then verifies the timing of signal paths between sequential elements, and between sequential elements and input/output terminals of the circuit. A sequential element is an element that is latched or clocked by a clock signal. The timing data indicates the time required for a signal to travel from one sequential element to another with respect to the clock signal. A timing violation occurs when a signal does not reach the intended sequential element during the appropriate clock cycle.

At step 620, if there are any timing violations, the logic designer can make changes to the schematic diagram or HDL specification, at step 608, update logic synthesis, at step 610, change the placement of cells, at step 614, or change the routing, at step 616.

Once all of the timing violations have been corrected, an integrated circuit layout definition is prepared, at step 622, which includes a netlist of the selected cells and the interconnections between the cells. The definition further includes placement data for the cells, routing data for the interconnections between the cells and cell layout definitions. The cell layout definitions include layout patterns of the interconnected transistors, local cell routing data and geometry data for the interconnected transistors. The integrated circuit layout definition is then used to fabricate the integrated circuit at step 624.

Since the command processor 410 allows the user to call various design tools at any time, the conventional flow elements 606-624 can be performed in any sequence, as desired by the designer. However, the general flow is still applicable. Moreover, though the invention has thus far been described as if the user calls each design tool, it is possible to run the design process as a batch process, meaning that the command processor simply loads and runs each design tool in a predefined sequence to produce the integrated chip.

Turning now to FIGS. 7 and 8, as previously discussed, in order to integrate custom logic from customers, it is sometimes necessary to access netlists and/or cell databases produced by a customer which may be in an unknown format. The graphics engine tool 432 can access and draw information from any database into a visual window, making the contents of the database accessible without the tool 432 having to know anything about the structure of the database.

FIG. 7 shows a simplified block diagram of the graphical engine tool 432 according to the present invention. As shown, the graphics engine 700 is taken out of the context of the suite, for the sake of clarity. The graphics engine 700 interfaces with an operating system display rendering module 702, and can be initialized with any number of database interfaces 704 (only one database interface 704 is shown for simplicity). The display rendering module 702 is generally a component of the operating system of a computer, which draws graphical elements to an external display device 706, such as a monitor, a television screen, an LCD display and the like. The database interface 704 is generally the interface that is specific to a particular database 708. The interface 704 itself is not generally part of the graphics engine 700 (although in an alternative embodiment, the interface 704 could be incorporated in the graphics engine 700).

Generally, the graphics engine 700 interacts with the database by sending a “draw” request 710 to the database interface 704. The draw request 710 is generally a standard database query. The request 70 itself may require a rudimentary knowledge of at least the type of database being queried, in order to frame the request properly.

In response to the request, the database sends a “world extent” parameter 712 and a “draw primitives” instruction 714. The world extent parameter 712 simply tells the graphics engine 700 how large the database is. The draw primitives instruction 714 tells the graphics engine 700 about the contents of the database in terms of primitive graphics (e.g. lines, basic shapes and the like). In other words, the database 708 returns a world extent 712 and a draw primitives 714 instruction to the database interface 704, which passes the information to the graphics engine 700. The graphics engine 700, passes the information to the display rendering module 702, which displays the primitive drawings on the display device 706.

Simply put, the database 708 tells the database interface 704 that it has a line extending from point A to point B. The information is passed to the graphics engine 700, which instructs the display rendering module to draw the line, and so on. Thus, the graphics engine tool 432 is a particularly useful design tool in the suite, because it provides a tool for displaying the database contents of any database, without concern for the specific database formats and so on. Thus, the cell layout for any circuit element can be graphically displayed.

In general, neither the graphics engine 700 nor the rendering module 702 need to know anything about the structure or contents of the database 708. More particularly, the rendering module 702 does not know anything more than that there is a line at a pixel location. The graphics engine 700 and display rendering module 702 render the contents of the database as graphical objects within the graphical user interface or GUI 412.

User interactions with the database contents rendered in the GUI 412 simply trigger a re-draw request to the graphics engine 700. So, if the user zooms in, a redraw request is triggered. The graphics engine 700 simply re-queries the database 708 to draw itself, and the display rendering module 702 simply redraws the primitives at a different scale.

In general, the data returned by the database 708 is responsive to two queries, the size of the universe or “world” and the content graphics. The size of the world then is returned to the graphics engine 700 so that the graphics engine 700 is aware of the window scope that will be displayed, while the graphics rendering module 702 simply instructs the GUI 412 to draw lines in particular places. The result is a graphical view of the contents of the database 708. For example, if the database were a list of names and addresses, the graphics interpreter would simply draw the lines of the letters or characters stored in the database. In the case of a circuit block or structure, the graphics interpreter draws lines where such lines exist within the circuit element.

With this graphics engine tool 432, the graphics subsystem can be almost completely separate from the underlying database 708. The graphic system does not need to know the underlying database or the data types it is asked to display. Conversely, the database need not have any knowledge of the graphics device or subsystem.

In general, the graphics engine 700 is designed to interface with the display device 706, whatever that device may be. In this particular embodiment, the display device 706 may be the command processor window on a computer workstation. However, the graphic subsystem can be used with any device, including cellular phones with image display capabilities, personal digital assistance (PDA), or any other display device, or even a printer. The graphics engine 700 need only know how to draw graphics without concern for the device to which the graphics are being drawn.

Typically, the database 708 itself contains information about the data and the data type stored in the database 708. The database 708 need not have any direct interaction with the display device 706. Typically, a subsystem referred to as a database interface (DBI) 704 is written for any database 708.

The graphics engine 700 can be initialized with any number of arbitrary DBIs 704. The graphics subsystem need only know two things about a particular DBI. First, the handle to any DBI function it calls whenever the database needs to be displayed should be known. Second, the world coordinates or extent (the maximum area the database may want to display) should also be known.

The DBI 704 knows only that the graphics engine 700 can be called to render geometries (graphic primitives) and text to an arbitrary device on arbitrary layers. The DBI 704 has no notion of when the display needs to be re-drawn or if the user has requested to zoom in or out of a certain area or has changed other user interface parameters, such as layer changes, repaint due to windows being cover/uncovered, and the like.

When a user triggers a re-draw (such as when a user alters the size of the display window, chooses to zoom in or out on the display, or when the GUI itself decides it is time to re-draw the database, for reasons such as layer change, repaint due to a window being covered and uncovered, or whatever, the GUI 412 then simply calls back the graphics engine 700 to re-draw the graphic primitives it wishes to display. This simple technique provides powerful capability to view multiple independent database types simultaneously using the same graphic subsystem.

Thus, at a high level, the graphics engine 700 interacts with unknown databases 708 on request from a user or the GUI itself. The unknown databases 708 can be of any content, but are particularly intended to be circuit layout databases.

To support new databases 708, one needs to provide a single class and a new constructor for the program, which should be similar to the “WVC open access draw” command (the “Draw( )” member). The draw database call needs to only know about the draw class member of the DBI 704. In one embodiment, WVC main canvas draw is initialized with an open access database object and its draw function eventually ends up calling the databases draw function. Thus, the graphics engine 700 just makes calls to the database 708 to draw itself.

The open access draw function is a database interface draw function. This class is given the handle to the graphics engine and requires access to the primitive drawing routine, such as draw rectangle, draw polygon, and the like. Typically, the open access draw function has full knowledge of the data type and structure of the database 708, because it typically is a fragment associated with the database 708 or the DBI 704. Additionally, the function is fully isolated from details of the graphic device 706 to which the primitives are drawn. For example, the draw request and the output from the database are fully independent of the display device 706 such that the same routines can be used to draw to a screen or to a printer without change.

FIG. 8 illustrates a simplified flow diagram of the operation of the graphics engine 700. Once the user creates a database view room and window using the command processor (step 800), the user makes a request to draw a particular database, usually by adding a circuit element to the layout. The command processor initializes the database interface for the particular database (step 802). Then the command processor initializes the graphics engine (step 804). The graphics engine connects to the database interface (step 806), and requests a draw event, entering an event loop (step 808). If a draw or re-draw is needed (step 810), the graphics engine calls the database to draw itself (step 812). The DBI 704 of the database 708 “walks” the database (step 814). In other words, the DBI 704 scans the database 708, calling out primitives.

The database 708 and graphics engine 700 communicate to draw graphical primitives such as lines, and basic shapes, effectively re-drawing or drawing for the first time the contents of a database to a window. First, the DBI 704 provides the graphics engine 700 with the “world extent” (the maximum area of the database 708) (step 816). Then, the DBI 704 calls the graphics engine 700 to draw primitives (step 818). Once the information is drawn, the graphics engine remains in the event loop 808-818 checking to see if a re-draw is needed. Whenever a re-draw is needed, the communication between the database and the graphics engine repeats. Otherwise, if a re-draw is not needed, the graphics remain the same.

The database-independent graphics engine 700 provides a user and the system with the capability of accessing the contents of numerous databases 708, without concern for the particular database interface 704. By simply adding the appropriate call function and constructors, the graphics engine 700 can quickly access and re-draw the data from any database 708. Additionally, by allowing the database contents to be rendered graphically, the database independent graphics engine 700 has the capability to display dissimilar databases simultaneously. In other words, databases 708 from different formats can be accessed at the same time using the same graphics engine 700 with minimal code difference.

The database independent graphics engine 700 provides substantial productivity improvements over previous database tools. In particular, the database independent graphics engine 700 is capable of supporting a graphical unrelated chip design database types. This allows for the system to work with customers having various modular or black box design tools. Additionally, since the same software code for drawing and the same graphics engine 700 are used, regardless of the database accessed, the system according to one embodiment of the present invention is able to render consistent graphics. Thus the user is presented the same type of graphical information regardless of the underlying database and data types. This reduces the training time required to train skilled workers to work with this application.

Thus, in addition to providing a fully customizable interface for facilitating IC fabrication, the present invention also links to a graphics engine 700 for rendering consistent graphics of varying database contents.

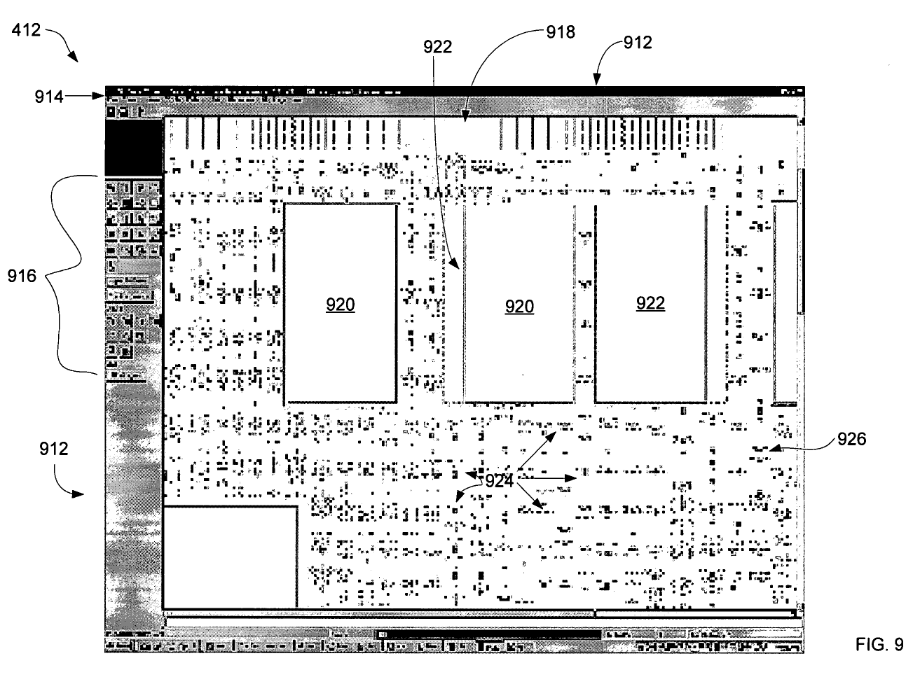

FIG. 9 illustrates a screen shot of the user-specified graphical user interface 412 according to one embodiment of the present invention. The graphical user interface window 910 includes a window pane 912, a tool bar 914, buttons 916, and a graphical rendering of primitive objects corresponding to a circuit structures arranged on a microchip or pre-fabricated silicon slice, with Input/output (IOs) 918 across the top, diffused memory blocks 920, RCELL Megacell blocks 922, and RCELLS 924 distributed on the slice.

As shown, tool bar 914 includes menus with menu items and the button bar 916 shows various buttons with associated functions. The entire graphical user interface 412, as previously discussed, is user-specified through TCL commands interpreted by the command interpreter 414 at run time. Thus, the user can create a fully customized graphical user interface 412 to suit his or her needs.

Additionally, the chip slice shown in the display window 926 may have been constructed using various design tools from the suite of design tools 218, or alternatively may be a display of the contents of a database 708 drawn using the graphics engine 700 (shown in FIG. 7). In either case, the graphical rendering is consistent across databases and across design tools. By providing a custom user interface and a consistent graphical view, the designer can create his or her preferred look and feel for the GUI, and enjoy a consistent graphical representation, regardless of the database accessed or the specific tool used.

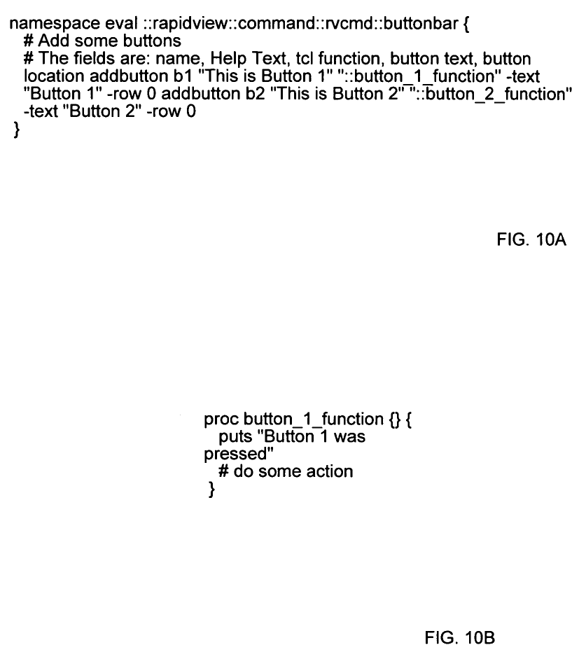

FIGS. 10A and 10B are pseudo-coded TCL scripts for implementing an object within the GUI and for calling an associated function based on user interaction with the object, respectively. As shown in FIG. 10A, the pseudo code adds some buttons to the button bar and assigns a TCL function to each button. FIG. 10B shows some pseudo code for calling a function or performing an action when the user interacts with Button 1 created by the pseudo code of FIG. 10A.

While the above-discussion has been discussion has largely been directed to the Tool Command Language (TCL) and a TCL interpreter, it will be understood by a worker skilled in the art that the fully customizable GUI can be implemented using other interpreted programming languages. Moreover, although the present invention has been described with reference to preferred embodiments, workers skilled in the art will recognize that changes may be made in form and detail without departing from the spirit and scope of the invention.

1. A command processor on a computer system comprising:
a graphical user interface for providing a graphical interface to the computer system; and
a command interpreter for interpreting commands from a user and for modifying the graphical user interface according to the interpreted commands.

2. The command processor of claim 1 wherein the graphical user interface is modifiable by the user at run time.

3. The command processor of claim 1 wherein the command interpreter interprets user commands to produce graphical objects within the graphical user interface.

4. The command process of claim 3 wherein the command interpreter interprets user commands to assign functionality to the graphical objects.

5. The command processor of claim 1 and further comprising:
a suite of integrated circuit design tools, each design tool of the suite having a functionality corresponding to one or more steps in a design flow process of an integrated circuit.

6. The command processor of claim 5 wherein the command processor loads each design tool into the graphical user interface based on user commands.

7. The command processor of claim 1 and further comprising:
a graphics engine tool for drawing contents of a database into the graphical user interface based on a user command.

8. A method of providing a fully customizable graphical user interface comprising:
upon execution of a command processor, loading a top level TCL command into a namespace;
building graphical objects according to TCL commands;
assigning functionality to the built graphical objects according to TCL commands; and
displaying a user-interactive window containing the graphical objects according to TCL commands.

9. The method of claim 8 and further comprising:
performing functions based on user interactions with the graphical objects according to their assigned functionality.

10. The method of claim 8 wherein the graphical objects are selected from a group consisting of windows, window panes, buttons, and menus.

11. The method of claim 8 wherein the step of assigning comprises:
creating a TCL script corresponding to a circuit design function; and
assigning the TCL script to one of the graphical objects.

12. The method of claim 11 wherein the one of the graphical objects is a button.

13. The method of claim 11 wherein the one of the graphical objects is an item within a pull-down menu.

14. The method of claim 8 and further comprising:
changing a look and feel of the graphical user interface during a circuit design process.

15. The method of claim 14 wherein the step of changing comprises:
creating new graphical objects using TCL commands; and
assigning functionality to the new graphical objects.

16. The method of claim 14 wherein the step of changing comprises:
loading a new top level TCL command into the namespace;
building graphical objects according to the new top level TCL commands;
assigning functionality to the built graphical objects according to the new TCL commands; and
displaying the user-interactive window containing the graphical objects according to the new TCL commands.

17. The method of claim 8 wherein before the step of building, the method further comprises:
creating a TCL interpreter object;
connecting input and output channels; and
creating room builder objects.

18. The method of claim 8 wherein the steps of building and assigning comprises:
loading a user specified TCL command configuration script.

19. A method of providing a graphical user interface having no hard coded objects, the method comprising:
loading a top level TCL command into a namespace upon execution of a command processor;
providing a command interpreter for interpreting commands from a user; and
assembling a graphical user interface based on interpreted commands from the user;
wherein all objects within the graphical user interface are user defined.

20. The method of claim 19 and further comprising:
changing the graphical user interface based on changing commands from the user; and
displaying a changed graphical user interface during operation based on the changing commands.

21. The method of claim 19 and further comprising:
interfacing with a suite of integrated circuit design tools for producing a integrated circuit layout and associated netlist.

22. The method of claim 21 wherein the step of interfacing comprises:
loading a design tool from the suite of design tools into the graphical user interface based on a user command.

23. The method of claim 22 wherein the user command is assigned to a graphical object.

24. An integrated circuit software design suite comprising:
a command processor having a graphical user interface and a command interpreter for interpreting user commands, the graphical user interface specified entirely by a user at run time; and
one or more design tools corresponding to processes within an integrated circuit design process;
wherein the one or more design tools operate under control of the command processor and within the graphical user interface.
